(19) United States
(12) Patent Application Publication
(10) Pub. No.: US 2024/0347825 A1
(43) Pub. Date: Oct. 17, 2024

(54) ENERGY STORAGE CELL

(71) Applicant: Carl Freudenberg KG, Weinheim (DE)

(72) Inventors: Markus CLEMENS, Reichelsheim (DE); Loubna BARGHOUT, Weinheim (DE); Carsten FORMER, Gorxheimertal (DE); Guenter ZIEGLER, Mannheim (DE); Juergen MALL, Duesseldorf (DE)

(21) Appl. No.: 18/294,563

(22) PCT Filed: Aug. 4, 2022
(86) PCT No.: PCT/EP2022/071978

§ 371 Date: Feb. 2, 2024

(30) Foreign Application Priority Data
Aug. 5, 2021 (DE) 10 2021 120 392.9

(51) Int. Cl. H01M 50/152; H01M 10/0525; H01M 50/107; H01M 50/186; H01M 50/193; H01M 50/198; H01M 50/578

(52) U.S. Cl. CPC H01M 50/152; H01M 10/0525; H01M 50/107; H01M 50/186; H01M 50/193; H01M 50/198; H01M 50/578

(57) ABSTRACT

An energy storage cell, including a housing closed by a cover and an electrolyte assembly, which is accommodated in the housing. The cover is provided with an outer contact element for establishing electric contact between the energy storage cell and an energy load. The outer contact element is connected to an intermediate element in an electrically conductive manner. The intermediate element is connected to an inner contact element in an electrically conductive manner. The intermediate element and the inner contact element are connected to each other in an electrically conductive manner by a contact zone provided with a predetermined breaking point. A sealing element is provided, which electrically insulates the intermediate element and the inner contact element outside of the contact zone and which causes sealing and electric insulation of the cover with respect to the housing.

### CROSS REFERENCE TO RELATED APPLICATIONS

This application is a U.S. National Phase application under 35 U.S.C. § 371 of International Application No. PCT/EP2022/071978, filed on Aug. 4, 2022, and claims benefit to German Patent Application No. DE 10 2021 120 392.9, filed on Aug. 5, 2021. The International Application was published in German on Feb. 9, 2023 as WO 2023/012284 A1 under PCT Article 21(2).

### FIELD

The invention relates to an energy storage cell.

### BACKGROUND

A configuration is known, for example, from US 2006/0263649 A1. Energy storage cells of this type are often formed circular when viewed from above, they have a cylindrical housing and a circular cover. Correspondingly, such energy storage cells are often referred to as cylindrical cells and have a standard length of 70 mm and a standard diameter of 21 mm. Such cylindrical cells are commercially available under the designation 2170, or 21700.

The cover element includes three electrically conductively connected disc-like elements, wherein the intermediate element and the inner contact element are connected to each other, for example, by a welded connection. At the same time, the welded connection can implement a predetermined breaking point. Alternatively, the predetermined breaking point can also be implemented by an intentional indentation. When there is an undesirable increase in pressure in the interior of the energy storage cell, the intermediate element and the inner contact element can be detached from each other via the predetermined breaking point so that the poles of the energy storage cell are deenergized. To implement this, it has been necessary to provide a plurality of electrically insulating elements between the elements of the cover, in particular, to arrange them between the two contact elements, in the region of the intermediate element outside of the contact zone, as well as between the cover and the housing. This results in relatively high manufacturing costs since it is necessary to position the insulating elements between the electrically conductive elements in a precisely fitting fashion.

### SUMMARY

In an embodiment, the present disclosure provides an energy storage cell, comprising a housing closed by a cover and an electrolyte assembly, which is accommodated in the housing. The cover is provided with an outer contact element for establishing electric contact between the energy storage cell and an energy load. The outer contact element is connected to an intermediate element in an electrically conductive manner. The intermediate element is connected to an inner contact element in an electrically conductive manner. The intermediate element and the inner contact element are connected to each other in an electrically conductive manner by a contact zone provided with a predetermined breaking point. A sealing element is provided, which electrically insulates the intermediate element and the inner contact element outside of the contact zone and which causes sealing and electric insulation of the cover with respect to the housing.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a sectional view of an energy storage cell; and

FIG. 2 schematically shows a detail sectional view of a cover.

### DETAILED DESCRIPTION

In an embodiment, the present invention provides an energy storage cell which can be simply and cost-effectively manufactured.

The energy storage cell comprises an electrolyte assembly, which is accommodated in a housing, wherein the housing is closed by a cover, wherein the cover is provided with an outer contact element for establishing electric contact between the energy storage cell and an energy load, wherein the outer contact element is connected to an intermediate element in an electrically conductive manner, wherein the intermediate element is connected to an inner contact element in an electrically conductive manner, wherein the intermediate element and the inner contact element are connected to each other in an electrically conductive manner via a contact zone provided with a predetermined breaking point, wherein a sealing element is provided, which electrically insulates the intermediate element and the inner contact element outside of the contact zone and which causes sealing and electric insulation of the cover with respect to the housing.

Correspondingly, the cover of the energy storage cell according to an embodiment of the invention includes only a single sealing element, which causes both sealing and electric insulation of the cover with respect to the housing, and electric insulation of the intermediate element with respect to the inner contact element outside of the electrically conductive contact zone. This reduces the part count of the cover, so that the cover can be more easily and more cost-effectively manufactured. By having the sealing element joining the elements of the cover with each other, an easily mountable composite cover is created.

To achieve a more basic configuration of the cover, the intermediate element to be omitted and for the sealing element to join the outer contact element and the inner contact element to each other. In this embodiment, the functions of the intermediate element can be performed by a sensor system which, in the case of a malfunction, causes electric decoupling.

The energy storage cell can be formed as a cylindrical cell and can have a cylindrical housing, which is closed by a cover at one end side. Preferably, the housing is formed of a metallic material, wherein the housing is preferably made by means of deep drawing so that the housing has a cylindrical outer side wall and a bottom formed throughout of one material and in one piece. Herein the bottom of the housing can be formed for establishing electric contact between the energy storage cell and an energy load.

The sealing element is preferably formed of an elastomeric material capable of being injection molded. This further simplifies manufacturability of the cover. For manufacture, the electrically conductive elements are arranged in an injection mold, then the elastomeric material capable of being injection molded is used to multi-component injection mold the sealing element. In this context, it is advantageous, in particular, to use ethylene propylene diene monomer (EPDM) as a material of the sealing element. Basically, the elastomeric material is preferably a cross-linked elastomeric material which, while coking at high temperatures, does not melt. This ensures functioning of the sealing element even at high temperatures, which can occur, for example, in the case of damage to an energy storage cell. Such a material is EPDM, for example. Basically, however, the use of cost-effective thermoplastic materials, such as polybutylene terephthalate (PBT), perfluoroalkoxy polymers (PFA) or polyphenylene sulfide (PPS), is also conceivable.

Preferably, the sealing element is formed throughout of the same material and in one piece. This allows the cover to be manufactured in a particularly simple and cost-effective manner.

The sealing element can surround the outer contact element and the intermediate element on its outer circumference. This allows sealing of the cover with respect to the housing to be particularly easily implemented.

The sealing element can cover the outer contact element and the intermediate element in an outer circumferential peripheral zone at the two end sides. In this configuration, the cover can be connected to the housing, for example, by means of crimping, wherein the housing partially covers the cover at both end sides after completion of the crimping process.

The outer contact element, the intermediate element and the inner contact element are preferably of a metallic material and thus cost-effectively and easily manufacturable and have good electric conductivity.

The intermediate element and the inner contact element can be metallurgically connected to each other to form the predetermined breaking point. To implement this, the intermediate element and the inner contact element are preferably metallurgically connected to each other by means of a welding connection, for example by means of spot welding. This ensures that the two elements are connected to each other in an electrically conductive manner. The spot-welding method can be carried out in such a way that a predetermined breaking point is created having a predefined breaking-off force.

The predetermined breaking point is preferably centrally formed on the intermediate element and the inner contact element.

Alternatively, it is conceivable for the predetermined breaking point to be created by a first indentation created in the inner contact element. Herein, the first indentation is preferably formed in such a manner that it defines the contact zone in an annular shape. Should the pressure inside the energy storage cell surmount a predetermined value, the inner contact element breaks open along the predetermined breaking point, wherein the contact zone is detached from the inner contact element so that the electric connection to the electric pole of the cover is interrupted.

The intermediate element can be provided with a further predetermined breaking point. This is preferably formed in the shape of a second indentation. The second indentation is preferably created in the intermediate element on the side facing the inner contact element. The further predetermined breaking point is triggered when the pressure inside the energy storage cell is further increased and surmounts a second predetermined value. By opening the further predetermined breaking point, a pressure compensation toward the environment can be achieved. To enable pressure compensation, the inner contact element and the outer contact element have openings in them. This can prevent the housing from breaking open at an undesirable place.

The intermediate element can have a disc shape at least in the peripheral zone. This allows the intermediate element to be particularly easily and cost-effectively manufactured.

Embodiments of the energy storage cell of the present invention will be described in the following with reference to the drawing figures in more detail.

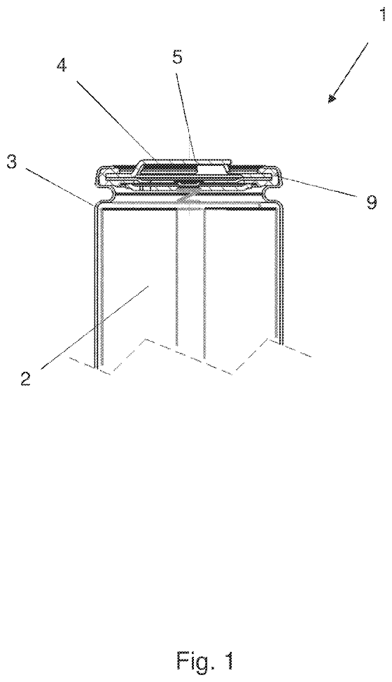

FIG. 1 shows an electrochemical energy storage cell 1 in the form of a cylindrical cell, 21 mm in diameter and 70 mm in length. The energy storage cell 1 comprises an electrolyte assembly 2 in the form of a jelly roll, which is accommodated in a housing 3.

In the present embodiment, the energy storage cell 1 is formed as a lithium-ion storage battery, wherein the electrolyte assembly 2 has two current conductors and two separators, wherein the current conductors are separated from each other by the separators. The current conductors have an active material applied to them, and the two current conductors separated by the separators are wound to a round structure, the jelly roll. The housing 3 is of a metallic material and has a cylindrical shape. At an end side, the housing 3 has a bottom formed throughout of the same material and in one piece with the cylindrical side wall of the housing 3. At the end side opposite the bottom, the housing 3 is closed by means of a cover 4. To fix the cover 4, the housing is deformed in sections by means of crimping so that the cover 4 is fixedly connected to the housing 3. The two electric contacts of the energy storage cell 1 are implemented by the bottom of the housing 2 and the outer contact element 5 of the cover 4. To achieve this, the housing 2 and the outer contact element 5 are electrically insulated by a sealing element 9.

Energy storage cells 1 of the type illustrated in FIG. 1 are variously used in engineering, for example in electric mobility, in battery electric vehicles, but also in electrically driven manual tools.

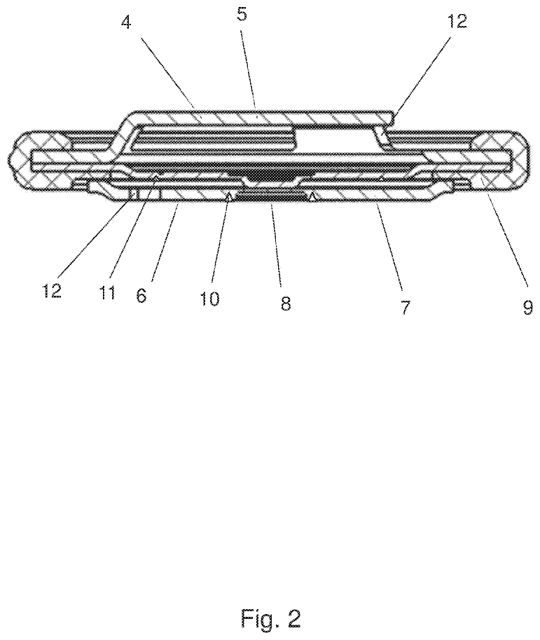

FIG. 2 shows a detail view of the cover 4 of the energy storage cell 1 shown in FIG. 1. The cover 4 is provided with an outer contact element 5 for establishing electric contact between the energy storage cell 1 and an energy load. The second contact is implemented by the bottom of the housing 3. The outer contact element 5 is connected to an intermediate element 6 in an electrically conductive manner, wherein the intermediate element 6, in turn, is connected to an inner contact element 7 in an electrically conductive manner. The inner contact element 7 faces into the interior of the housing 3. The intermediate element 6 and the inner contact element 7 are connected to each other in an electrically conductive manner by a contact zone 8. Herein, the contact zone 8 has a predetermined breaking point 10 associated with it, which is created by an annularly shaped first indentation, wherein the first indentation is created on the side of the inner contact element 7 facing towards the housing 3. If the pressure inside the energy storage cell 1 surmounts a predetermined value, the inner contact element 7 breaks open along the predetermined breaking point 10, wherein the contact zone 8 is detached from the inner contact element 7 so that the electric connection of the electrolyte assembly 2 to the electric pole of the cover 4 is interrupted.

A further predetermined breaking point 11 is created in the intermediate element 6, which is also implemented by a further annular indentation. The further indentation of the further predetermined breaking point 11 is created in the intermediate element 6 at the side facing the inner contact element 7. The further predetermined breaking point 11 is triggered when the pressure inside the energy storage cell 1 is further increased and surmounts a second predetermined value. By opening the further predetermined breaking point 11, a pressure compensation towards the environment can be achieved. To enable unhindered pressure compensation, openings 12 are provided in the inner contact element 7 and the outer contact element 5.

The cover 4 further includes a sealing element 9 which electrically insulates the intermediate element 6 and the inner contact element 7 outside of the contact zone 8 and which causes sealing and electric insulation of the cover 4 with respect to the housing 3. The sealing element 9 is formed of an injection moldable, elastomeric material and, in the present embodiment, is of ethylene propylene diene monomer (EPDM). The sealing element 9 which causes sealing of the cover 4 with respect to the housing 3 and electric insulation of the intermediate element 6 and the inner contact element 7 outside of the contact zone 8 is formed throughout of the same material and in one piece.

The sealing element 9 further surrounds the outer contact element 5 and the intermediate element 6 at its outer circumference, furthermore the sealing element 9 covers the outer contact element 5 and the intermediate element 6 in an outer circumferential peripheral zone at both end sides.

The outer contact element 5, the intermediate element 6 and the inner contact element 7 are formed of a metallic material. The intermediate element 6 and the inner contact element 7 are metallurgically connected to each other by means of spot welding to create the predetermined breaking point in the region of the contact zone 8. Herein, the predetermined breaking point is centrally formed at the intermediate element 6 and the inner contact element 7. The intermediate element 6 has a disc shape at least in the peripheral zone.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An energy storage cell, comprising:
a housing closed by a cover; and
an electrolyte assembly, which is accommodated in the housing,
wherein the cover is provided with an outer contact element for establishing electric contact between the energy storage cell and an energy load,
wherein the outer contact element is connected to an intermediate element in an electrically conductive manner,
wherein the intermediate element is connected to an inner contact element in an electrically conductive manner,
wherein the intermediate element and the inner contact element are connected to each other in an electrically conductive manner by a contact zone provided with a predetermined breaking point, and
wherein a sealing element is provided, which electrically insulates the intermediate element and the inner contact element outside of the contact zone and which causes sealing and electric insulation of the cover with respect to the housing.

2. The energy storage cell according to claim 1, wherein the energy storage cell is formed as a cylindrical cell and the housing is cylindrical, and wherein the housing is closed by the cover at an end side.

3. The energy storage cell according to claim 1, wherein the sealing element is formed of an injection moldable, elastomeric material.

4. The energy storage cell according to claim 3, wherein the sealing element is formed of EPDM.

5. The energy storage cell according to claim 1, wherein the sealing element is formed throughout of the same material and in one piece.

6. The energy storage cell according to claim 1, wherein the sealing element circumferentially surrounds the outer contact element and the intermediate element.

7. The energy storage cell according to claim 6, wherein the sealing element covers the outer contact element and the intermediate element in an outer circumferential peripheral zone at both end sides.

8. The energy storage cell according to claim 1, wherein the outer contact element, the intermediate element and the inner contact element are formed of a metallic material.

9. The energy storage cell according to claim 1, wherein the intermediate element and the inner contact element are metallurgically connected to each other to create the predetermined breaking point.

10. The energy storage cell according to claim 1, wherein a first indentation is created in the inner contact element to create the predetermined breaking point.

11. The energy storage cell according to claim 10, wherein the first indentation of the predetermined breaking point has an annular shape and defines the contact zone.

12. The energy storage cell according to claim 1, wherein the predetermined breaking point is centrally formed on the intermediate element and the inner contact element.
